(19) United States
(12) Patent Application Publication
(10) Pub. No.: US 2022/0335907 A1
(43) Pub. Date: Oct. 20, 2022

(54) DYNAMIC LOCAL DIMMING DISPLAY CONTROL METHOD AND APPARATUS, AND DISPLAY DEVICE

(71) Applicant: BOE Technology Group Co., Ltd., Beijing (CN)

(72) Inventors: Bingchuan SHI, Beijing (CN); Xitong MA, Beijing (CN); Tianmin RAO, Beijing (CN)

(21) Appl. No.: 17/762,010

(22) PCT Filed: Mar. 10, 2021
(86) PCT No.: PCT/CN2021/079851

§ 371 Date: Mar. 18, 2022

(30) Foreign Application Priority Data
Apr. 30, 2020 (CN) 202010360889.X

(51) Int. Cl. G09G 3/34; G09G 3/20

(52) U.S. Cl. CPC G09G 3/3426; G09G 3/2007; G09G 2360/16; G09G 2320/0626; G09G 2320/0242

(57) ABSTRACT

The present disclosure provides a dynamic local dimming display control method and apparatus, and a display device, and the method includes: determining a grayscale statistical function of each display partition according to a grayscale of an image to be displayed; obtaining a grayscale control parameter of each display partition, where the grayscale control parameter is related to an overflow rate; calculating a backlight control signal of each backlight partition according to the grayscale control parameter and the grayscale statistical function of each display partition; determining a compensated grayscale value according to the backlight control signal of each backlight partition and a backlight diffusion model; and performing image display according to the compensated grayscale value. The present disclosure can ensure that a pixel overflow rate in pixel compensation is not greater than a preset value.

### CROSS-REFERENCE TO RELATED APPLICATIONS

This application claims a priority to the Chinese Patent Application No. 202010360889. X filed in China on Apr. 30, 2020, which is herein incorporated by reference in its entirety.

### TECHNICAL FIELD

Embodiments of the present disclosure relate to the field of display technology, in particular to a dynamic local dimming display control method and apparatus, and a display device.

### BACKGROUND

In the field of high-brightness display, a liquid crystal display panel will reduce contrast of a display screen due to its inherent phenomenon of light leakage. In order to improve the contrast of the display screen, dynamic local dimming technologies are widely used in the field of high-quality display. Different from the traditional liquid crystal display panel illumination using uniform backlight, the dynamic local dimming technologies use a partition backlight scheme. In the scheme, the liquid crystal display panel is divided into M*N (row*column) partitions, each partition has an independently controllable backlight. When a dark screen is displayed, backlight brightness can be adjusted down to reduce light leakage and improve the contrast of the screen. At the same time, the backlight can be adjusted downward to effectively reduce power consumption of a whole machine, which has particular significance for mobile devices and ultra-large-size display devices.

In early dynamic local dimming technologies, the liquid crystal display panel is divided into several partitions in the row and column direction respectively, and dozens of partitions in total are provided. With miniaturization of Light Emitting Diode (LED) backlights and development of control technologies, it becomes possible to provide more partitions for the display panel. There has been a dynamic local dimming display product that is divided into hundreds of backlight partitions in the row and column respectively, totaling tens of thousands of backlight partitions.

The dynamic local dimming technology lowers a backlight brightness based on an existing backlight, and in order to ensure a theoretical brightness output of the display screen, it is necessary to increase a grayscale of corresponding pixels in the display panel (to increase a transmission rate of the panel) as compensation. However, the grayscale of the display panel cannot be increased infinitely. For a common 8-bit display panel, the maximum grayscale thereof is only 255, and once the compensated grayscale is greater than 255, grayscale overflow may be caused. The grayscale overflow can cause color shift of the display. Therefore, how to determine the appropriate regional backlight brightness to limit the grayscale overflow becomes a core of the dynamic local dimming technology.

### SUMMARY

The embodiments of the present disclosure provide a dynamic local dimming display control method and apparatus, and a display device, so as to solve the problem of grayscale overflow caused by the existing dynamic local dimming technology.

In order to solve the above technical problem, the present disclosure is achieved as follows.

In a first aspect, the embodiments of the present disclosure provide a dynamic local dimming display control method, and method includes: determining a grayscale statistical function of each display partition according to a grayscale of an image to be displayed; obtaining a grayscale control parameter of each display partition, where the grayscale control parameter is related to an overflow rate; calculating a backlight control signal of each backlight partition according to the grayscale control parameter and the grayscale statistical function of each display partition; determining a compensated grayscale value according to the backlight control signal of each backlight partition and a backlight diffusion model; and performing image display according to the compensated grayscale value.

Optionally, the calculating the backlight control signal of each backlight partition according to the grayscale control parameter and the grayscale statistical function of each display partition includes: determining a critical overflow grayscale of each display partition according to a grayscale statistical function and a grayscale control parameter of a grayscale image of each display partition; determining a critical backlight brightness of each backlight partition according to the critical overflow grayscale of each display partition; determining an initial backlight control signal of each display partition according to the critical backlight brightness of each backlight partition; and determining a target backlight control signal of each backlight partition according to the initial backlight control signal of each backlight partition, where the target backlight control signal of each backlight partition is a maximum value of an initial backlight control signal of a neighborhood of the backlight partition, and the neighborhood of the backlight partition includes the backlight partition and a plurality of peripheral backlight partitions.

Optionally, the determining the compensated grayscale value according to the backlight control signal of each backlight partition and the backlight diffusion model includes: determining backlight brightness information of each pixel on a display panel according to the backlight control signal of each backlight partition and the backlight diffusion model; and determining a compensated grayscale value of each pixel according to the backlight brightness information of each pixel.

Optionally, the grayscale statistical function is a grayscale-cumulative distribution function, and the determining the grayscale statistical function of each display partition according to the grayscale of the image to be displayed includes: for each display partition, obtaining a grayscale value of each pixel in a grayscale image of the display partition; obtaining a probability density distribution function of each grayscale value; and obtaining a grayscale-cumulative distribution function of the grayscale image of the display partition according to the probability density distribution functions of all grayscale values in the display partition.

Optionally, the grayscale control parameter is a preset overflow rate value, and the grayscale statistical function is a grayscale-cumulative distribution function; and the determining the critical overflow grayscale of each display partition according to the grayscale statistical function and the grayscale control parameter of the grayscale image of each display partition includes: determining a grayscale corresponding to a cumulative distribution probability k as the critical overflow grayscale according to the grayscale-cumulative distribution function, where k is equal to 1-p, and p is the overflow rate value.

Optionally, the determining the critical backlight brightness of each backlight partition according to the critical overflow grayscale of each display partition includes: determining the critical backlight brightness Lt of each backlight partition by using the following formula: Lt=Lmax*(Gt/Gmax)\hat{ }gamma, where Lmax is an original brightness value of a backlight, gamma is a gamma value of the display panel, \hat{ } is a power exponent operation, Gt is the critical overflow grayscale, and Gmax is a maximum grayscale value.

Optionally, a size of the neighborhood is a 3×3 or 5×5 backlight partition.

Optionally, the determining the compensated grayscale value of each pixel according to the backlight brightness information of each pixel includes: calculating a compensation rate S of each pixel on the display panel, S=(Lmax/Lnew)\hat{ }(1/gamma), where Lmax is an original backlight brightness value of a pixel, Lnew is backlight brightness information of the pixel obtained by calculation, gamma is a gamma value of the display panel, and \hat{ } is a power exponent operation; and determining the compensated grayscale Gnew of each pixel, Gnew=Gori*S, where Gori is an original grayscale value of the pixel.

Optionally, subsequent to the determining the compensated grayscale value of each pixel comprises, the method further includes: when the compensated grayscale value is greater than a maximum grayscale value, lowering the compensation rate to make the compensated grayscale value equal to the maximum grayscale value.

Optionally, prior to the determining the grayscale statistical function of each display partition according to the grayscale of the image to be displayed, the method further includes: converting the image to be displayed from a color image into a grayscale image.

In a second aspect, the embodiments of the present disclosure provide a dynamic local dimming display control apparatus, and the apparatus includes: a first determination module, configured to determine a grayscale statistical function of each display partition according to a grayscale of an image to be displayed; an obtaining module, configured to obtain a grayscale control parameter of each display partition, wherein the grayscale control parameter is related to an overflow rate; a calculation module, configured to calculate a backlight control signal of each backlight partition according to the grayscale control parameter and the grayscale statistical function of each display partition; a second determination module, configured to determine a compensated grayscale value according to the backlight control signal of each backlight partition and a backlight diffusion model; and a display module, configured to perform image display according to the compensated grayscale value.

In a third aspect, the embodiments of the present disclosure provide a display device, and the device includes the dynamic local dimming display control apparatus described above.

In a fourth aspect, the embodiments of the present disclosure provide a display device, and the display device includes a processor, a memory, and a computer program stored on the memory and executable by the processor, where the computer program, when executed by the processor, performs the steps of the dynamic local dimming display control method described above.

In a fifth aspect, the embodiments of the present disclosure provide a computer readable storage medium, where the computer program is stored on the readable storage medium, and the program, when executed by the processor, performs the steps of the dynamic local dimming display control method described above.

In the embodiments of the present disclosure, the backlight control signal of each backlight partition is determined based on the grayscale control parameter related to the overflow rate and the grayscale statistical function of each display partition, and then the grayscale value to be compensated of the pixel is determined, thereby ensuring that a pixel overflow rate in pixel compensation is not greater than a preset value.

### BRIEF DESCRIPTION OF THE DRAWINGS

Various other advantages and benefits will become apparent to those of ordinary skill in the art by reading the detailed description of the preferred embodiment below. The accompanying drawings are for the purpose of illustrating the preferred embodiment only and are not considered to be limiting of the present disclosure. Moreover, throughout the accompanying drawings, the same reference symbols are used to indicate the same components. In the drawings:

FIG. 1 is a schematic diagram showing backlights in different partitions of a display panel mutual crosstalk to form uniform backlight;

FIG. 2 is a diagram showing distribution of measured backlight brightness with respect to distance (pixels) compared with distribution of backlight brightness with respect to distance (pixels) using a double Gaussian fitting;

FIG. 3 is a schematic diagram showing backlight crosstalk causing more backlight brightness reduction than expected;

FIG. 4 is a schematic flowchart of a dynamic local dimming display control method according to an embodiment of the present disclosure;

FIG. 5 is a schematic diagram of a grayscale-probability density function according to an embodiment of the present disclosure;

FIG. 6 is a schematic diagram of a grayscale-cumulative distribution function according to an embodiment of the present disclosure;

FIG. 7 is a schematic diagram of a method for converting an initial backlight control signal array Lt (m, n) into a backlight control signal array Lc (m, n);

FIG. 8 is a schematic diagram of backlight brightness according to an embodiment of the present disclosure;

FIG. 9 is a schematic flowchart of a dynamic local dimming display control method according to another embodiment of the present disclosure; and

FIG. 10 is a schematic structural diagram of a dynamic local dimming display control apparatus according to an embodiment of the present disclosure.

### DETAILED DESCRIPTION

The following clearly and completely describes the technical solutions in the embodiments of this disclosure with reference to the accompanying drawings in the embodiments of this disclosure. Apparently, the described embodiments are merely some rather than all of the embodiments of this disclosure. All other embodiments obtained by persons of ordinary skill in the art without creative efforts based on the embodiments of this disclosure shall fall within the protection scope of this disclosure.

In the related dynamic local dimming approaches, the earlier adopted approaches, such as the mean-value approach, the root-square approach and the maximum-value approach, use a simple way to determine a backlight control signal, and the disadvantage is that an overflow rate cannot be controlled at all.

With increase of onboard computing resources, a backlight determination algorithm based on pixel statistics improves control of the overflow rate to a certain extent. However, in these algorithms, a calculation basis of the overflow rate is that backlight brightness is uniform within a backlight partition, i.e., a backlight control signal is directly used as backlight. This approach is applicable in the case of fewer partitions and small backlight crosstalk between partitions. However, the illumination region of a light source has a certain range, within which the backlight brightness gradually decreases from the middle to the periphery; in addition, crosstalk between backlight (light mixing) is also an important condition for forming the uniform backlight.

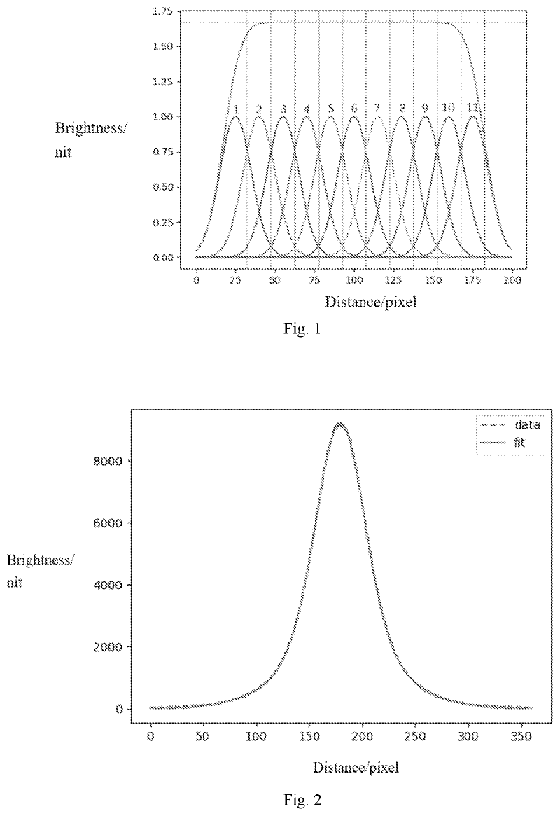

With reference to FIG. 1, FIG. 1 is a schematic diagram showing backlights in different partitions of a display panel mutual crosstalk to form uniform backlight. In FIG. 1, backlights of 11 partitions are shown, and each backlight distribution is a Gaussian distribution L_{psf.n}(d)=exp(−(d−μₙ)²/2σ²), where L is brightness, d is distance in a unit of pixel (pix), μ n is a mean value and σ is a variance, and an abscissa of a coordinate axis in FIG. 1 is the distance (d) in the unit of pixel (pix), an ordinate thereof is brightness (L) in the unit of nit. When μₙ=25+15*n,σ=10 where n is the number of partitions, the equal amount of backlights of each partition are diffused and overlapped to form the uniform backlight. For the sake of illustration, only one-dimensional beam diffusion is shown in FIG. 1, and the actual beam diffusion is two-dimensional.

With reference to FIG. 2, FIG. 2 is a diagram showing distribution of measured backlight brightness with respect to distance (pixels) compared with distribution of backlight brightness with respect to distance (pixels) using a double Gaussian fitting; the solid curve is measurement data (data), the dotted curve is double Gaussian fitting data (fit), and it can be seen from FIG. 2 that the double Gaussian fitting can well match the measurement results.

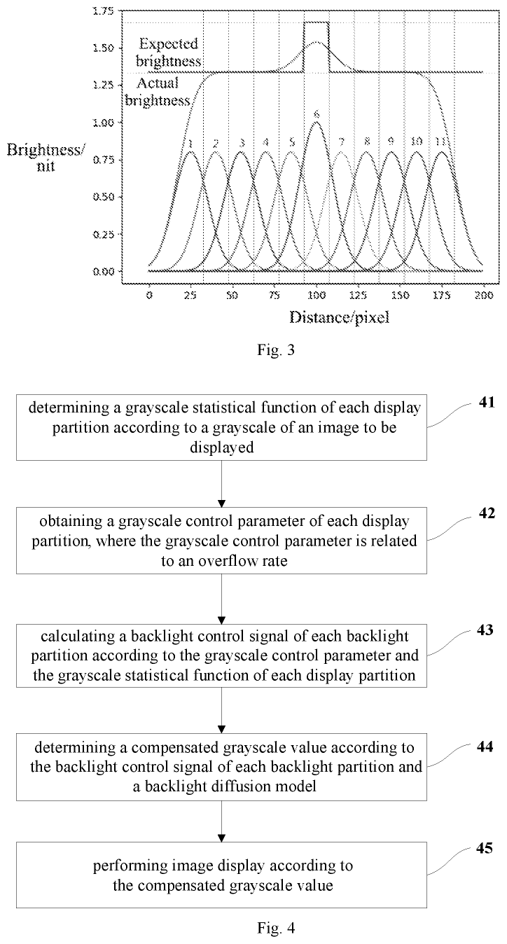

In the case of backlight partition dimming, the backlight crosstalk causes the brightness of the backlight in a region to not strictly correspond with a backlight control signal, which will lead to actual backlight brightness in the region will be lower than a brightness level corresponding to the backlight control signal if a dimming ratio of the backlight in an adjacent partition is higher than a dimming ratio of the backlight in this partition. FIG. 3 is a schematic diagram showing backlight crosstalk causing more backlight brightness reduction than expected. In FIG. 3, the brightness corresponding to the backlight control signal of the partition 6 is maintained at 1, and the brightness corresponding to the backlight control signal of the peripheral partition is reduced to 0.8. Without considering crosstalk, the partition 6 should maintain an expected brightness (with reference to FIG. 3, the expected brightness corresponding to the partition 6 is about 1.65). In fact, since the backlight component of the peripheral light source radiating to partition 6 is reduced, the contribution of the peripheral partition to the partition 6 is reduced, and the partition 6 can no longer maintain the original backlight brightness (with reference to FIG. 3, the actual brightness corresponding to the partition 6 is about 1.5). However the brightness reduction caused by this situation is not taken into account in the calculation of the overflow rate. Since the calculation of the overflow rate is based on the backlight control signal of the present partition, while the actual backlight brightness in the partition is lower than the expected brightness corresponding to the backlight control signal, this will lead to the number of pixels that need to be compensated and the degree of compensation are higher than expected, causing the overflow rate to exceed the standard.

In order to solve the above-mentioned problems, referring to FIG. 4, the embodiments of the present disclosure provide a dynamic local dimming display control method, and the method includes the following steps.

Step 41: determining a grayscale statistical function of each display partition according to a grayscale of an image to be displayed.

In the embodiments of the present disclosure, the display panel is divided into a plurality of display partitions. Optionally, a display region of the display panel may be divided into M*N (row*column) display partitions, and further optionally, M and N are both positive integers more than 1.

Step 42: obtaining a grayscale control parameter of each display partition, where the grayscale control parameter is related to an overflow rate.

Step 43: calculating a backlight control signal of each backlight partition according to the grayscale control parameter and the grayscale statistical function of each display partition.

In the embodiments of the present disclosure, a backlight source is divided into a plurality of backlight partitions. Optionally, the backlight region of the backlight source may be divided into M*N (row*column) backlight partitions, further optionally, M and N are both positive integers more than 1. Optionally, there is a one-one correspondence between the backlight partition and the display partition.

Step 44: determining a compensated grayscale value according to the backlight control signal of each backlight partition and a backlight diffusion model.

Step 45: performing image display according to the compensated grayscale value.

In the embodiments of the present disclosure, the backlight control signal of each backlight partition is determined based on the grayscale control parameter related to the overflow rate and the grayscale statistical function of each display partition, and then the grayscale value to be compensated of the pixel is determined, thereby ensuring that a pixel overflow rate in pixel compensation is not greater than a preset value.

In some embodiments of the present disclosure, prior to the determining the grayscale statistical function of each display partition according to the grayscale of the image to be displayed, the method further includes: converting the image to be displayed from a color image into a grayscale image.

In some embodiments of the present disclosure, when the image to be displayed in the display panel to be input is converted from the color image to a grayscale image, a maximum value among RGB (red, green, and blue) components of each pixel of the color image may be taken as a grayscale value of the corresponding pixel in the grayscale image because the maximum value among RGB components is directly related to the overflow rate.

Of course, in other embodiments of the present disclosure, other methods may be used to convert the color image to the grayscale image, such as an average of the RGB components of each pixel of the color image is taken as the grayscale value of the corresponding pixel in the grayscale image.

In the embodiments of the present disclosure, optionally, the grayscale statistical function is a grayscale-cumulative distribution function (CDF). The cumulative distribution function (CDF) is an integral of a Probability Density Function (PDF), and can completely describe probability distribution of a real random variable X. In the embodiments of the present disclosure, the real random variable X is the grayscale.

Of course, in other embodiments of the present disclosure, the grayscale statistical function may be other types of functions.

In the embodiments of the present disclosure, when the grayscale statistical function is the grayscale-cumulative distribution function, the determining the grayscale statistical function of each display partition according to the grayscale of the image to be displayed includes the following steps.

Step 411: the grayscale value of every pixel in the grayscale image of the display partition is obtained for each display partition;

Step 412: the probability density distribution function of every grayscale value is obtained; and

Step 413: the grayscale-cumulative distribution function of the grayscale image of the display partition is obtained according to the probability density distribution function of all grayscale values in the display partition.

In the following description of definition of the probability density function, it is assumed that there are NO pixels with the grayscale 0, N1 pixels with the grayscale 1, . . . , and Ni pixels with the grayscale i in the grayscale image, where i is less than or equal to 255; the total number of pixels in the grayscale image is Nt; then the probability density distribution function PDF(i)=Ni/Nt for the grayscale i.

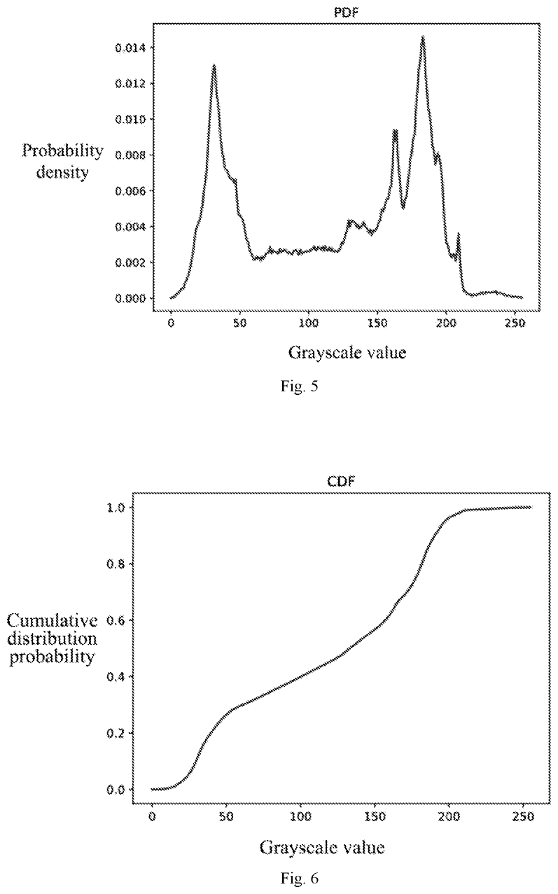

With reference to FIGS. 5 and 6, FIG. 5 is a schematic diagram of a grayscale-probability density function according to an embodiment of the present disclosure, and FIG. 6 is a schematic diagram of a grayscale-cumulative distribution function according to an embodiment of the present disclosure. The use of PDF and CDF is a relatively simple way to count probability information of the grayscale.

In the embodiments of the present disclosure, optionally, the calculating the backlight control signal of each backlight partition according to the grayscale control parameter and the grayscale statistical function of each display partition includes the following steps.

Step 431: determining a critical overflow grayscale of each display partition according to a grayscale statistical function and a grayscale control parameter of a grayscale image of each display partition.

In the embodiments of the present disclosure, optionally, the grayscale control parameter is a preset overflow rate value.

The overflow rate is a ratio of the number of pixels overflowing in grayscale to the total pixel data. The so-called overflow refers to that, for example, for an 8-bit image, the grayscale exceeding 255 is overflow.

In the embodiments of the present disclosure, the overflow rate value is a preset value, and the preset value may be set based on empirical values. In the embodiments of the present disclosure, the overflow rate of each display partition is the same.

In the embodiments of the present disclosure, the critical overflow grayscale of each display partition may be determined by the following way: determining the grayscale corresponding to the cumulative distribution probability k as the critical overflow grayscale according to the grayscale-cumulative distribution function, where k is equal to 1-p, and p is the overflow rate.

The significance of the critical overflow grayscale is that, when the critical overflow grayscale Gt overflows, pixels with a grayscale higher than Gt have overflowed with a percentage p, while a portion with a percentage k will not overflow because the gray scale is lower than Gt.

Of course, in other embodiments of the present disclosure, it is not excluded that the grayscale control parameter is other parameters, such as multiplying the overflow rate by a specified coefficient, etc.

Step 432: determining a critical backlight brightness of each backlight partition according to the critical overflow grayscale of each display partition.

In the embodiments of the present disclosure, optionally, the critical backlight brightness Lt of each backlight partition is determined by using the following formula:

Lt=Lmax*(Gt/Gmax)\hat{ }gamma

where Lmax is an original brightness value of a backlight, gamma is a gamma value of the display panel, \hat{ } is a power exponent operation, Gt is the critical overflow grayscale, and Gmax is a maximum grayscale value. For example, for an 8-bit image, Gmax is 255.

Step 433: determining an initial backlight control signal of each display partition according to the critical backlight brightness of each backlight partition.

In the embodiments of the present disclosure, the backlight brightness has a mapping relationship with the backlight control signal, and the mapping relationship can be predetermined.

The initial backlight control signals for each backlight partition may form an initial backlight control signal array Lt (m, n).

Step 434: determining a target backlight control signal of each backlight partition according to the initial backlight control signal of each backlight partition, wherein the target backlight control signal of each backlight partition is a maximum value of an initial backlight control signal of a neighborhood of the backlight partition, and the neighborhood of the backlight partition comprises the backlight partition and a plurality of peripheral backlight partitions.

Optionally, a size of the neighborhood is a 3×3 backlight partition (3 rows and 3 columns of backlight partition) or a 5×5 backlight partition (5 rows and 5 columns of backlight partition), or other larger neighborhood. The specific size is determined according to the degree of influence of the backlight partition by the peripheral backlight partitions. Optionally, the present backlight partition is located in the center of the neighborhood.

The target backlight control signals for each backlight partition can form a target backlight control signal array Lc (m, n).

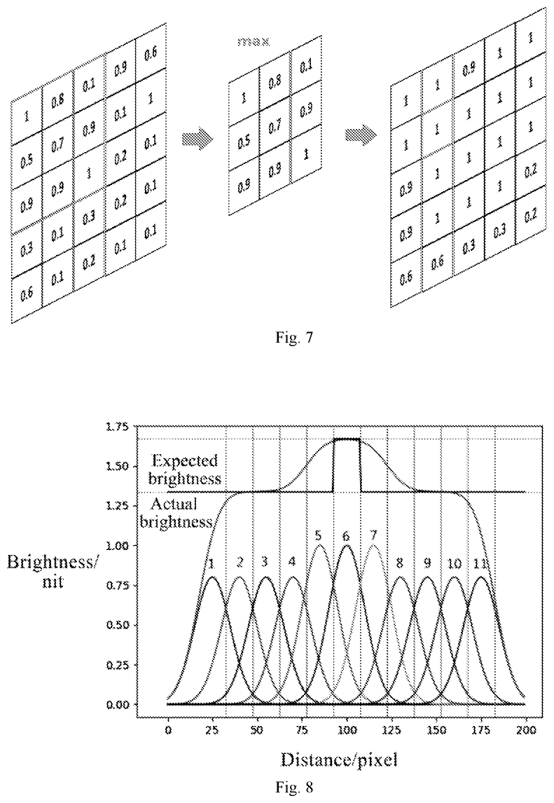

With reference to FIG. 7, FIG. 7 is a schematic diagram of a method for converting an initial backlight control signal array Lt (m, n) into a backlight control signal array Lc (m, n). In the embodiment shown in FIG. 7, the size of the neighborhood is the 3×3 backlight partition.

In the embodiments of the present disclosure, the target backlight control signal of each backlight partition is the maximum value of the initial backlight control signal in its neighborhood, and it can be ensured that after the backlight of the peripheral backlight partitions of the present backlight partition is lowered, the brightness of the present backlight partition is not lower than a theoretical value (namely, the expected brightness) obtained from calculation of the present backlight partition.

With reference to FIG. 8, FIG. 8 is a schematic diagram of backlight obtained by using the above-mentioned method. In the embodiments of the present disclosure, the 3×3 backlight partition of the neighborhood is adopted. As can be seen from FIG. 8, the actual brightness of the partition 6 is about 1.65, substantially achieving the expected brightness.

In the embodiments of the present disclosure, considering crosstalk of the backlights between each backlight partition, the maximum value in the neighborhood is used to determine the backlight control signal of the present partition before determining the backlight control signal of each backlight partition, so as to ensure that the backlight of the present partition is not lower than the theoretical value, thereby ensuring that a pixel overflow rate in pixel compensation is not greater than a preset value.

In the embodiments of the present disclosure, optionally, the determining the compensated grayscale value according to the backlight control signal of each backlight partition and the backlight diffusion model includes the following steps.

Step 441: determining backlight brightness information of each pixel on a display panel according to the backlight control signal of each backlight partition and the backlight diffusion model. When the backlight diffusion model is a single group of backlight lighting, backlight two-dimensional distribution condition on the back of the display panel can be measured by an imaging luminance meter to get data, and then a mathematical model is then obtained by data denoising and fitting.

In the embodiments of the present disclosure, optionally, the backlight diffusion model is created by using a multi-Gaussian fitting method. The multi-Gaussian fitting method can be well used to create the backlight diffusion model, for example, the measurement data shown in FIG. 1 can be well fitted by using a double-Gaussian distribution.

The backlight signal is an array of discrete backlight spots, and the light emitted by each backlight spot is diffused via a diffusion plate and appears as a planar light source on the display panel. Mathematically, the process can be obtained by convolving the backlight signal of each point with a backlight diffusion model.

That is, in the embodiments of the present disclosure, the backlight control signal of each back light spot can be convoluted with the backlight diffusion model to obtain backlight brightness information of each pixel on the display panel.

Step 442: determining a compensated grayscale value of each pixel according to the backlight brightness information of each pixel.

In the embodiments of the present disclosure, the compensated grayscale value of each pixel can be determined by the following steps.

Step 4421: calculating a compensation rate S of each pixel on the display panel, S=(Lmax/Lnew)\hat{ }(1/gamma), where Lmax is an original backlight brightness value of a pixel, Lnew is backlight brightness information of the pixel obtained by calculation, gamma is a gamma value of the display panel, and \hat{ } is a power exponent operation.

Step 4422: determining the compensated grayscale value Gnew of each pixel, Gnew=Gori*S, where Gori is an original grayscale value of the pixel.

The grayscale overflow can cause a color shift of the pixel, resulting in poor display that is more pronounced than brightness distortion. Thus, in the embodiments of the present disclosure, optionally, in the case where the theoretically calculated compensation rate S results in grayscale overflow (e.g. the compensation rate may be multiplied by the RGB components respectively, and if the maximum value of the three products is greater than the maximum grayscale value (e.g. 255), then it is judged that there is an overflow), the compensation rate S needs to be lowered according to the overflow rate in actual compensation, for example, so that max(R, G, B)*S=255. At this time, the maximum value in the RGB channel is compensated to 255 grayscale and reaches saturation, while the other channels are not saturated, which can avoid the color shift caused by the actual overflow.

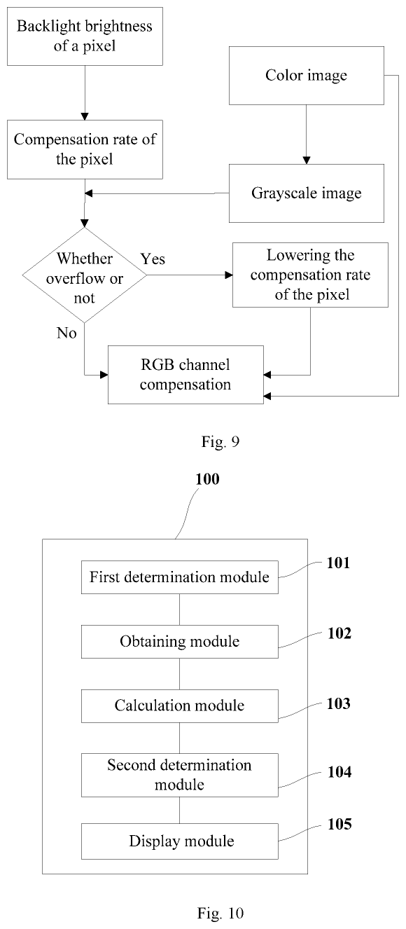

That is, in the embodiments of the present disclosure, optionally, referring to FIG. 9, subsequent to the determining the compensated grayscale value of each pixel comprises, the method further includes: when the compensated grayscale value is greater than a maximum grayscale value, lowering the compensation rate to make the compensated grayscale value equal to the maximum grayscale value.

The dynamic local dimming display control method in the embodiments of the present disclosure is applicable to the case where the display panel is divided into an exceedingly large number of display partitions and there is crosstalk in the backlight between the display partitions.

Based on the same disclosed concept, referring to FIG. 10, the present disclosure also provides a dynamic local dimming display control apparatus 100, the apparatus includes: a first determination module 101 configured to determine a grayscale statistical function of each display partition according to a grayscale of an image to be displayed; an obtaining module 102 configured to obtain a grayscale control parameter of each display partition, wherein the grayscale control parameter is related to an overflow rate; a calculation module 103 configured to calculate a backlight control signal of each backlight partition according to the grayscale control parameter and the grayscale statistical function of each display partition; a second determination module 104 configured to determine a compensated grayscale value according to the backlight control signal of each backlight partition and a backlight diffusion model; and a display module 105 configured to perform image display according to the compensated grayscale value.

Optionally, the calculation module 103 includes: a first determination sub-module configured to determine a critical overflow grayscale of each display partition according to a grayscale statistical function and a grayscale control parameter of a grayscale image of each display partition; a second determination sub-module configured to determine a critical backlight brightness of each backlight partition according to the critical overflow grayscale of each display partition; a third determination sub-module configured to determine an initial backlight control signal of each display partition according to the critical backlight brightness of each backlight partition; and a fourth determination sub-module configured to determine a target backlight control signal of each backlight partition according to the initial backlight control signal of each backlight partition, where the target backlight control signal of each backlight partition is a maximum value of an initial backlight control signal of a neighborhood of the backlight partition, and the neighborhood of the backlight partition includes the backlight partition and a plurality of peripheral backlight partitions.

Optionally, the second determining module 104 includes: a fifth determination sub-module configured to determine backlight brightness information of each pixel on a display panel according to the backlight control signal of each backlight partition and the backlight diffusion model; and a sixth determination sub-module configured to determine a compensated grayscale value of each pixel according to the backlight brightness information of each pixel.

Optionally, the grayscale statistical function is the grayscale-cumulative distribution function, and the first determination module 101 includes: a first obtaining sub-module configured to, for each display partition, obtain a grayscale value of each pixel in a grayscale image of the display partition; a second obtaining sub-module configured to obtain a probability density distribution function of each grayscale value; and a third obtaining sub-module configured to obtain a grayscale-cumulative distribution function of the grayscale image of the display partition according to the probability density distribution functions of all grayscale values in the display partition.

Optionally, the grayscale control parameter is the preset overflow rate value, and the grayscale statistical function is a grayscale-cumulative distribution function; and the first determination sub-module is configured to determine a grayscale corresponding to a cumulative distribution probability k as the critical overflow grayscale according to the grayscale-cumulative distribution function, wherein k is equal to 1-p, and p is the overflow rate value.

Optionally, the second determination sub-module is configured to determine the critical backlight brightness Lt of each backlight partition by using the following formula:

Lt=Lmax*(Gt/Gmax)\hat{ }gamma

where Lmax is the original brightness value of the backlight, gamma is the gamma value of the display panel, \hat{ } is the power exponent operation, Gt is the critical overflow grayscale, and Gmax is the maximum grayscale value.

Optionally, a size of the neighborhood is a 3×3 backlight partition or the 5×5 backlight partition.

Optionally, a sixth determination sub-module is configured to calculate a compensation rate S of each pixel on the display panel, S=(Lmax/Lnew)\hat{ }(1/gamma), where Lmax is an original backlight brightness value of a pixel, Lnew is backlight brightness information of the pixel obtained by calculation, gamma is a gamma value of the display panel, and \hat{ } is a power exponent operation; and determine the compensated grayscale value Gnew of each pixel, Gnew=Gori*S, where Gori is an original grayscale value of the pixel.

Optionally, the apparatus further includes: an adjustment module configured to, when the compensated grayscale value is greater than a maximum grayscale value, lower the compensation rate to make the compensated grayscale value equal to the maximum grayscale value.

Optionally, the apparatus further includes: a conversion module configured to convert the image to be displayed from the color image into a grayscale image.

The embodiments of the present disclosure also provide a display device, including the dynamic local dimming display control apparatus described above.

The embodiments of the present disclosure also provide a display device, including a processor, a memory, and a computer program stored on the memory and executable by the processor, where the computer program, when executed by the processor, performs the steps of the dynamic local dimming display control method described above.

The embodiments of the present disclosure also provide a computer readable storage medium, where the computer program is stored on the readable storage medium, and the computer program, when executed by the processor, performs the steps of the dynamic local dimming display control method described above.

The embodiments of the present disclosure are described above with reference to the accompanying drawings, but the present disclosure is not limited to the above-described embodiments, which are merely illustrative and not restrictive. Those skilled in the art, in light of the present disclosure, can make other forms without departing from the spirit and scope of the present disclosure, all of which fall within the protection of the present disclosure.

1. A dynamic local dimming display control method, comprising:
determining a grayscale statistical function of each display partition according to a grayscale of an image to be displayed;
obtaining a grayscale control parameter of each display partition, wherein the grayscale control parameter is related to an overflow rate;
calculating a backlight control signal of each backlight partition according to the grayscale control parameter and the grayscale statistical function of each display partition;
determining a compensated grayscale value according to the backlight control signal of each backlight partition and a backlight diffusion model; and
performing image display according to the compensated grayscale value.

2. The dynamic local dimming display control method according to claim 1, wherein the calculating the backlight control signal of each backlight partition according to the grayscale control parameter and the grayscale statistical function of each display partition comprises:
determining a critical overflow grayscale of each display partition according to a grayscale statistical function and a grayscale control parameter of a grayscale image of each display partition;
determining a critical backlight brightness of each backlight partition according to the critical overflow grayscale of each display partition;
determining an initial backlight control signal of each display partition according to the critical backlight brightness of each backlight partition; and
determining a target backlight control signal of each backlight partition according to the initial backlight control signal of each backlight partition, wherein the target backlight control signal of each backlight partition is a maximum value of an initial backlight control signal of a neighborhood of the backlight partition, and the neighborhood of the backlight partition comprises the backlight partition and a plurality of peripheral backlight partitions.

3. The dynamic local dimming display control method according to claim 2, wherein the determining the compensated grayscale value according to the backlight control signal of each backlight partition and the backlight diffusion model comprises:
determining backlight brightness information of each pixel on a display panel according to the backlight control signal of each backlight partition and the backlight diffusion model; and
determining a compensated grayscale value of each pixel according to the backlight brightness information of each pixel.

4. The dynamic local dimming display control method according to claim 1, wherein the grayscale statistical function is a grayscale-cumulative distribution function, and the determining the grayscale statistical function of each display partition according to the grayscale of the image to be displayed comprises:
for each display partition, obtaining a grayscale value of each pixel in a grayscale image of the display partition;
obtaining a probability density distribution function of each grayscale value; and
obtaining a grayscale-cumulative distribution function of the grayscale image of the display partition according to the probability density distribution functions of all grayscale values in the display partition.

5. The dynamic local dimming display control method according to claim 2, wherein the grayscale control parameter is a preset overflow rate value, and the grayscale statistical function is a grayscale-cumulative distribution function; and
the determining the critical overflow grayscale of each display partition according to the grayscale statistical function and the grayscale control parameter of the grayscale image of each display partition comprises:
determining a grayscale corresponding to a cumulative distribution probability k as the critical overflow grayscale according to the grayscale-cumulative distribution function, wherein k is equal to 1-p, and p is the overflow rate value.

6. The dynamic local dimming display control method according to claim 2, wherein the determining the critical backlight brightness of each backlight partition according to the critical overflow grayscale of each display partition comprises:
determining the critical backlight brightness Lt of each backlight partition by using the following formula:
Lt=Lmax*(Gt/Gmax)\hat{ }gamma
wherein Lmax is the original brightness value of the backlight, gamma is the gamma value of the display panel, \hat{ } is the power exponent operation, Gt is the critical overflow grayscale, and Gmax is the maximum grayscale value.

7. The dynamic local dimming display control method according to claim 2, wherein a size of the neighborhood is a 3×3 backlight partition or a 5×5 backlight partition.

8. The dynamic local dimming display control method according to claim 3, wherein the determining the compensated grayscale value of each pixel according to the backlight brightness information of each pixel comprises:
calculating a compensation rate S of each pixel on the display panel,
S=(Lmax/Lnew)\hat{ }(1/gamma)
wherein Lmax is an original backlight brightness value of a pixel, Lnew is backlight brightness information of the pixel obtained by calculation, gamma is a gamma value of the display panel, and \hat{ } is a power exponent operation; and
determining the compensated grayscale value Gnew of each pixel,
Gnew=Gori*S,
wherein Gori is an original grayscale value of the pixel.

9. The dynamic local dimming display control method according to claim 8, wherein subsequent to the determining the compensated grayscale value of each pixel comprises, the method further comprises:
when the compensated grayscale value is greater than a maximum grayscale value, lowering the compensation rate to make the compensated grayscale value equal to the maximum grayscale value.

10. The dynamic local dimming display control method according to claim 1, wherein prior to the determining the grayscale statistical function of each display partition according to the grayscale of the image to be displayed, the method further comprises:
converting the image to be displayed from a color image into a grayscale image.

11. A dynamic local dimming display control apparatus, comprising:
a first determination module, configured to determine a grayscale statistical function of each display partition according to a grayscale of an image to be displayed;
an obtaining module, configured to obtain a grayscale control parameter of each display partition, wherein the grayscale control parameter is related to an overflow rate;
a calculation module, configured to calculate a backlight control signal of each backlight partition according to the grayscale control parameter and the grayscale statistical function of each display partition;
a second determination module, configured to determine a compensated grayscale value according to the backlight control signal of each backlight partition and a backlight diffusion model; and
a display module, configured to perform image display according to the compensated grayscale value.

12. A display device, comprising the dynamic local dimming display control apparatus according to claim 11.

13. A display device, comprising a processor, a memory, and a computer program stored on the memory and executable by the processor, wherein the computer program, when executed by the processor, performs the steps of the dynamic local dimming display control method according to claim 1.

14. A non-transitory readable storage medium, wherein a computer program is stored on the readable storage medium, and the program, when executed by the processor, performs the steps of the dynamic local dimming display control method according to claim 1.
